(19) United States
(12) Patent Application Publication
(10) Pub. No.: US 2021/0245880 A1
(43) Pub. Date: Aug. 12, 2021

(54) CONTROL METHOD AND DEVICE, SURVEYING UNMANNED AERIAL VEHICLE (UAV), AND SPRAYING UAV

(71) Applicant: SZ DJI TECHNOLOGY CO., LTD., Shenzhen (CN)

(72) Inventors: Guang YAN, Shenzhen (CN); Xianghua JIA, Shenzhen (CN); Dongdong MA, Shenzhen (CN); Xinchao LI, Shenzhen (CN); Jinsong LI, Shenzhen (CN)

(21) Appl. No.: 17/244,448

(22) Filed: Apr. 29, 2021

Related U.S. Application Data
(63) Continuation of application No. PCT/CN2018/113163, filed on Oct. 31, 2018.

(51) Int. Cl. B64D 1/18; B64C 39/02; G06K 9/00; G06N 3/08; G05D 1/00

(52) U.S. Cl. CPC B64D 1/18; B64C 39/024; G06K 9/00657; B64C 2201/14; G05D 1/0022; G05D 1/0094; B64C 2201/12; G06N 3/08

(57) ABSTRACT

A control method includes obtaining three-dimensional (3D) spatial information of a target crop area planted with a plurality of target crops; determining spraying control information based on the 3D spatial information; and controlling a spraying unmanned aerial vehicle (UAV) to perform spraying on the plurality of target crops based on the spraying control information. The spraying control information includes a spraying mode for controlling the spraying UAV to perform spraying on one target crop of the plurality of target crops, and the spraying mode includes a flight mode.

### CROSS-REFERENCE TO RELATED APPLICATION

This application is a continuation of International Application No. PCT/CN2018/113163, filed on Oct. 31, 2018, the entire content of which is incorporated herein by reference.

### TECHNICAL FIELD

The present disclosure relates to the technical field of unmanned aerial vehicle (UAV) and, more particularly, to a control method, device, surveying UAV, and spraying UAV.

### BACKGROUND

With the wide adoption of consumer UAVs, industrial UAVs are also gaining attractions. For agricultural and farming industry, agricultural UAVs play an important role in agricultural plant protection operations, such as spraying operation (spraying water, pesticides, seeds, etc.) The agricultural UAVs bring substantial benefits to the agricultural industry, for example, saving user's time, improving operation efficiency, boosting operation income, and increasing utilization rate of agricultural machinery.

However, the existing spraying methods are not intelligent and are inconvenient. Taking a sparsely planted target crop (e.g., fruit trees) for example, the existing technology requires manually marking a position of each target crop and then controlling a spraying UAV to spray each target crop. On one hand, manually marking is inefficient. On the other hand, manually marking may be impractical due to certain constraints such as substantially tall target crops.

### SUMMARY

In accordance with the disclosure, there is provided a control method. The method includes obtaining three-dimensional (3D) spatial information of a target crop area planted with a plurality of target crops; determining spraying control information based on the 3D spatial information; and controlling a spraying unmanned aerial vehicle (UAV) to perform spraying on the plurality of target crops based on the spraying control information. The spraying control information includes a spraying mode for controlling the spraying UAV to perform spraying on one target crop of the plurality of target crops, and the spraying mode includes a flight mode.

Also in accordance with the disclosure, there is provided a device. The device includes a memory storing program codes and a processor configured to execute the program codes to obtain three-dimensional (3D) spatial information of a target crop area planted with a plurality of target crops; determine spraying control information based on the 3D spatial information; and control a spraying unmanned aerial vehicle (UAV) to perform spraying on the plurality of target crops based on the spraying control information. The spraying control information includes a spraying mode for controlling the spraying UAV to perform spraying on one target crop of the plurality of target crops, and the spraying mode includes a flight mode.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a schematic diagram showing a surveying UAV surveying a target crop area according to an example embodiment of the present disclosure.

FIG. 2 is a schematic diagram showing an application scenario according to an example embodiment of the present disclosure.

FIG. 3 is a schematic diagram showing a spraying UAV spraying a plurality of target crops in the target crop area according to an example embodiment of the present disclosure.

FIG. 4 is a flowchart of a control method according to an example embodiment of the present disclosure.

FIG. 5 is a schematic diagram showing a spraying UAV circling over a target crop according to an example embodiment of the present disclosure.

FIG. 6 is a schematic diagram showing a spraying UAV vertically ascending and descending adjacent to a target crop according to an example embodiment of the present disclosure.

FIG. 7 is a schematic diagram showing a spraying UAV spirally circling around a target crop according to an example embodiment of the present disclosure.

FIG. 8 is a schematic diagram showing a spraying UAV horizontally circling around a target crop according to an example embodiment of the present disclosure.

FIG. 9 is a structural diagram of a surveying UAV according to an example embodiment of the present disclosure.

FIG. 10 is a structural diagram of a spraying control information determination device according to an example embodiment of the present disclosure.

FIG. 11 is a structural diagram of a spraying UAV according to an example embodiment of the present disclosure.

FIG. 12 is a structural diagram of a control system according to an example embodiment of the present disclosure.

### DETAILED DESCRIPTION OF THE EMBODIMENTS

To make the objectives, technical solutions, and advantages of the embodiments of the present disclosure clearer, the embodiments of the present disclosure are described with clarity and entirety below with reference to the accompanying drawings. It will be appreciated that the described embodiments are some rather than all of the embodiments of the present disclosure. Other embodiments obtained by those having ordinary skills in the art on the basis of the described embodiments without inventive efforts should fall within the scope of the present disclosure.

When a component is described as being “fixed to” another component, it may be directly on the other component or may be indirectly on the other component through an intermediate component. Similarly, when a component is described as being “connected to” another component, it may be directly on the other component or may be indirectly on the other component through an intermediate component.

Unless otherwise defined, all technical and scientific terms used here have the same meaning as commonly understood by those skilled in the art. The terms used in the description of the present disclosure are only for the purpose of describing specific embodiments, rather than limiting the present disclosure. The singular forms of “a,” “said,” and “the” used in the specification and claims of the present disclosure are also intended to include corresponding plural forms unless the context clearly indicates otherwise. It should be understood that the term “and/or” as used herein refers to any or all possible combinations of one or more listed items.

Although the terms “first,” “second,” and “third” are used to describe various information in the present disclosure, the information should not be limited to these terms. These terms are used to distinguish a same type of information from each other. For example, without departing from the scope of the present disclosure, the first information may also be referred to as the second information. Similarly, the second information may also be referred to as the first information. In addition, depending on the context, the term “if” can be interpreted as “when,” “while,” or “in response to.”

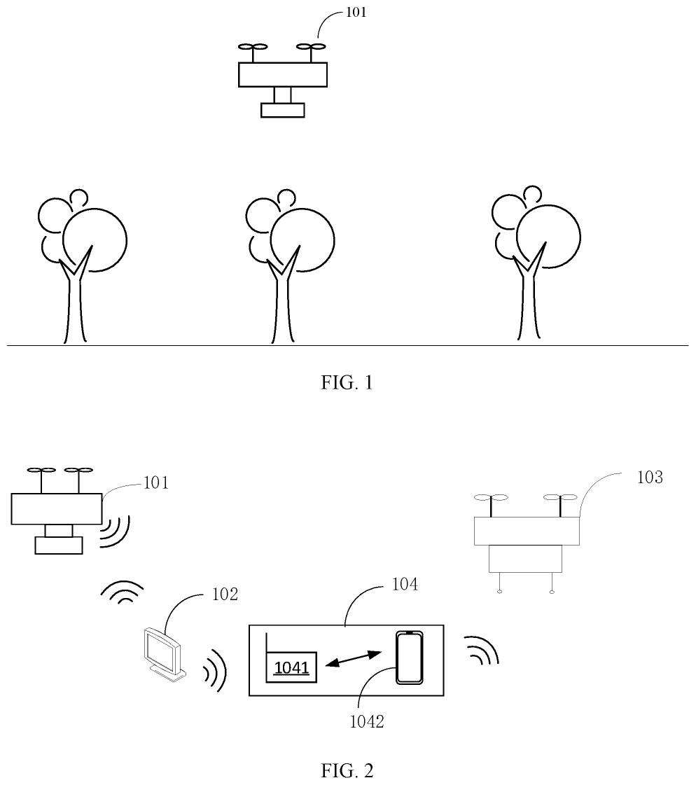

The present disclosure provides a control method and device, a surveying UAV, and a spraying UAV, which can be used in a scenario that the spraying UAV is controlled to spray a plurality of target crops in a crop area. FIG. 1 is a schematic diagram of a surveying UAV surveying a target crop area according to an example embodiment of the present disclosure. As shown in FIG. 1, the surveying UAV 101 is flying over a target crop area, and is using a photographing device disposed at the surveying UAV to photograph the target crop area. The plurality of target crops are planted in the target crop area. In some cases, the plurality of target crops are sparsely planted in the target crop area. The target crop may be any agricultural crops. Further, the target crop may be trees. The trees may include fruit trees, tea trees, rubber trees, etc. But the embodiments of the present disclosure are not limited thereto.

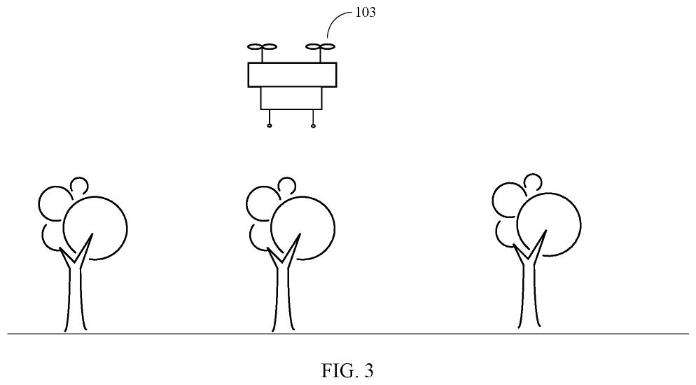

FIG. 2 is a schematic diagram showing an application scenario according to an example embodiment of the present disclosure. As shown in FIG. 2, the surveying UAV 101, a spraying control information determination device 102, a spraying UAV 103, and a ground control terminal 104 are included in the application scenario. The spraying control information determination device 102 may be a device that can determine spraying control information based on the three-dimensional spatial information of the target crop area as described above. For example, the spraying control information determination device 102 may include one or more of a remote controller, a smartphone, a desk-top computer, a laptop computer, a server, and a wearable device (e.g., watch, wrist band). For illustration purpose, the spraying control information determination device 102 will be described as a computer in the embodiments of the present disclosure. The ground control terminal 104 of the spraying UAV 103 may include one or more of a remote controller, a smartphone, a desk-top computer, a laptop computer, a server, and a wearable device (e.g., watch, wrist band). For illustration purpose, the ground control terminal 104 will be described as a remote controller 1041 and a terminal device 1042 in the embodiments of the present disclosure. For example, the terminal device 1042 may include a smartphone, a wearable device, and a tablet computer, etc., but the embodiments of the present disclosure are not limited thereto.

The surveying UAV 101 may obtain images outputted by the photographing device, and obtain 3D spatial information of the target crop area. The 3D spatial information of the target crop area is used to determine spraying control information for the spraying UAV to spray the plurality of target crops. The spraying control information determination device 102 may obtain the 3D spatial information of the target crop area from the surveying UAV 103 directly or indirectly through wired communication connection or wireless communication connection, and determine the spraying control information based on the 3D spatial information. The spraying control information is used to control the spraying UAV 103 to spray the plurality of target crops in the target crop area.

In some embodiments, the spraying control information determination device 102 may obtain the 3D spatial information of the target crop area by another method other than using the surveying UAV 101. The spraying UAV 103 may obtain the spraying control information from the spraying control information determination device 102 directly or indirectly through wired communication connection or wireless communication connection, and spray each target crop in the target crop area based on the spraying control information.

In some embodiments, the spraying control information determination device 102 may transmit the spraying control information to the ground control terminal 104 of the spraying UAV 103. The ground control terminal 104 of the spraying UAV 103 controls the spraying UAV 103 to spray the target crop area based on the information for controlling the spraying operation of the spraying UAV 103.

In some embodiments, the spraying control information determination device 102 may transmit the spraying control information to the spraying UAV 103. The spraying UAV 103 may spray each target crop in the target crop area based on the spraying control information, as shown in FIG. 3.

The embodiments of the present disclosure will be described in detail below with reference to the accompanying drawings. In case of no conflict, the following embodiments and features in the embodiments may be combined with each other.

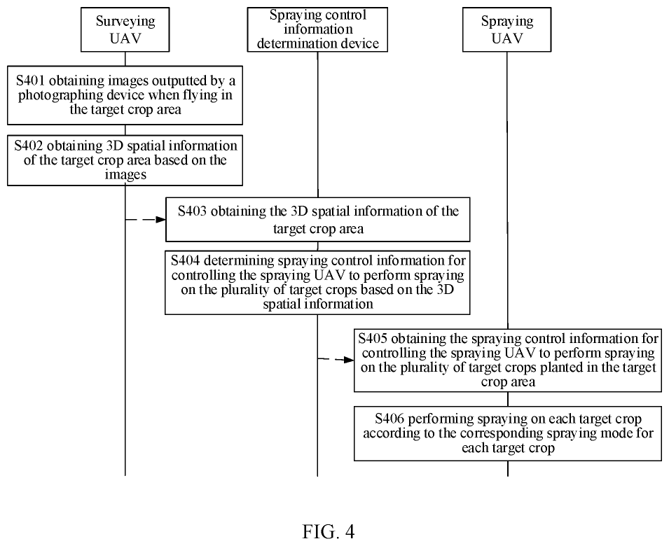

FIG. 4 is a flowchart of a control method according to an example embodiment of the present disclosure. As shown in FIG. 4, the control method includes the following processes.

At S401, the surveying UAV obtains the images outputted by the photographing device when flying over the target crop area.

In some embodiments, the surveying UAV is equipped with the photographing device. When flying over the target crop area, the photographing device disposed at the surveying UAV photographs the target crop area. As such, the surveying UAV obtains the images outputted by the photographing device. The surveying UAV flies in the target crop area according to a pre-planned route. When the surveying UAV is flying, the photographing device may photograph images at equal distance intervals or at equal time intervals.

The plurality of target crops are planted in the target crop area. In some embodiments, the plurality of target crops are a plurality of trees. In some embodiments, the plurality of trees are a plurality of fruit trees. The target crop of the present disclosure is not limited thereto.

At S402, the surveying UAV obtains the 3D spatial information of the target crop area based on the images.

In some embodiments, the surveying UAV may obtain the 3D spatial information of the target crop area based on the images outputted by the photographing device. The 3D spatial information of the target crop area is used to determine the spraying control information for controlling the spraying UAV to spray the plurality of target crops.

In some embodiments, when the surveying UAV is flying in the target crop area, the surveying UAV further obtains location information of the surveying UAV and attitude of the photographing device. Correspondingly, a possible implementation of S402 includes that the surveying UAV obtains the 3D spatial information of the target crop area based on the images, the location information, and the attitude. In some embodiments, the location information is provided by a real-time kinematic (RTK) positioning device. Thus, the obtained 3D spatial information is more accurate.

In some embodiments, the surveying UAV is equipped with a radar device. The radar device includes a millimeter wave radar or a lidar. When the surveying UAV is flying in the target crop area, the surveying UAV obtains first 3D spatial information outputted by the radar device. The surveying UAV obtaining the 3D spatial information of the target crop area based on the images includes: using the images to reconstruct second 3D spatial information of the target crop area, and using the first 3D spatial information to calibrate the second 3D spatial information to obtain the spatial information of the target crop area. Because the image quality is substantially affected by light when the photographing device photographs the target crop area (for example, the photographing device is backlit), the photographed images may be unclear or blurry, causing inaccurate reconstruction of the 3D spatial information based on the images. Thus, the first 3D spatial information is used to calibrate the second 3D spatial information to improve the accuracy of the 3D spatial information of the target crop area.

At S403, the spraying control information determination device obtains the 3D spatial information of the target crop area.

In some embodiments, the spraying control information determination device may obtain the 3D spatial information of the target crop area. In some embodiments, the 3D spatial information is determined based on the images outputted by the photographing device when the surveying UAV is flying in the target crop area. The description of S401 and S402 may be referred to for the exemplary implementation. In some embodiments, the 3D spatial information of the target crop area may be obtained in another way other than from the surveying UAV, which I snot limited by the present disclosure.

In some embodiments, the surveying UAV and the spraying control information determination device may be connected through a wired communication connection or a wireless communication connection. After the surveying UAV executes S402, the surveying UAV may transmit the 3D spatial information of the target crop area to the spraying control information determination device through a wired communication connection or a wireless communication connection. Correspondingly, a possible implementation of S403 includes that the spraying control information determination device receives the 3D spatial information of the target crop area transmitted from the surveying UAV through a wired communication connection or a wireless communication connection. The wired communication connection or the wireless communication connection may be a direct communication connection, that is, a point-to-point communication connection, or an indirect communication connection, that is, a communication connection through an intermediate device (e.g., the ground control terminal of the surveying UAV).

In some other embodiments, after the surveying UAV executes S402, the 3D spatial information is stored in a storage device. Correspondingly, a possible implementation of S403 includes that the spraying control information determination device retrieves the 3D spatial information from the storage device. The storage device may be, for example, a secure digital memory card (SD card). However, the embodiments are not limited thereto. The surveying UAV may store the obtained 3D spatial information in the SD card. A user may remove the SD card from the surveying UAV and plug the SD card into the spraying control information determination device. The spraying control information determination device reads the 3D spatial information from the plugged-in SD card.

At S404, the spraying control information determination device determines the spraying control information for controlling the spraying UAV to perform spraying on the plurality of target crops based on the 3D spatial information.

In some embodiments, after the spraying control information determination device obtains the 3D spatial information of the target crop area, the spraying control information determination device determines the spraying control information for controlling the spraying UAV to perform spraying on the plurality of target crops based on the 3D spatial information. The spraying control information is used to control the spraying UAV to spray the plurality of target crops. The spraying information includes a spraying mode for controlling the spraying UAV to spray each of the plurality of target crops. The spraying mode also includes a flight mode.

In some embodiments, the 3D spatial information includes 3D point cloud information or 3D map information. The 3D point cloud information includes 3D coordinates. In some cases, the 3D point cloud information also includes color information. A height value in the 3D coordinates may be used to distinguish the fruit trees, and the color information may also be used to distinguish the fruit trees. Taking apple trees as an example, the fruit trees including red information are determined to be the apple trees, and the more red information included in the fruit trees, the more apples grow on the fruit trees.

In some embodiments, the spraying control information also includes the flight route that the spraying UAV flies between the plurality of target crops planted in the target crop area.

In some embodiments, the spraying mode also includes one or more of spraying intensity and spraying density.

In some embodiments, to determine the spraying control information, the spraying control information determination device determines status information of the plurality of target crops in the target crop area based on 3D spatial information, and determines the spraying control information for controlling the spraying UAV to perform spraying on the plurality of target crops based on the status information of the plurality of target crops. The status information of the target crops is also referred to as “crop status information.”

The status information of the plurality of target crops includes at least one of location information of the plurality of target crops, quantity of the plurality of target crops, or growth information of the plurality of the target crops.

The spraying control information determination device may input the 3D spatial information into a pre-configured neural network model to obtain the status information of the plurality of target crops in the target crop area outputted by the pre-configured neural network model. The pre-configured neural network model may be convolutional neural network (CNN) that has already been properly trained.

In some embodiments, the spraying control information of the plurality of target crops is related to the status information of the plurality of target crops. Different status information of the plurality of target crops correspond to different spraying control information. As such, the spraying UAV may spray on the plurality of target crops differently based on different status information of the plurality of target crops, thereby making the spraying more targeted.

In some embodiments, the status information of the plurality of target crops includes the location information of the plurality of target crops and the quantity of the plurality of target crops. The spraying control information includes the flight route that the spraying UAV flies between the plurality of target crops. In some embodiments, determining the spraying control information based on the status information of the plurality of target crops includes that the spraying control information determination device determines the flight route that the spraying UAV flies between the plurality of target crops based on the location information of the plurality of target crops and the quantity of the plurality of target crops.

In some embodiments, if heights of the plurality of target crops vary substantially, the spraying control information determination device generates the flight route based on a higher flight height for safely flying to a target position. The generated flight route may be a shortest-time-consuming route or a minimum-power-consuming route of the spraying UAV, thereby substantially improving spraying efficiency of the spraying UAV.

In some embodiments, the status information of the plurality of target crops includes the growth information of the plurality of target crops. The spraying control information includes the spraying mode for controlling the spraying UAV to spray each of the plurality of target crops. In some embodiments, determining the spraying control information based on the status information of the plurality of target crops includes that the spraying control information determination device determines the spraying mode for controlling the spraying UAV to spray each corresponding target crop based on the growth information of each of the plurality of target crops. Therefore, different spraying modes may be customized for the plurality of target crops with different growth information, thereby ensuring that all the plurality of target crops with different growth information are effectively sprayed.

In some embodiments, the growth information includes at least one of a crop type of the plurality of target crops, a density coefficient of branches and leaves, a pest damage coefficient, a horizontal spreading range of branches and leaves, or height information of branches and leaves. The spraying mode includes one or more of the flight mode, the spraying intensity, and the spraying density.

In some embodiments, the spraying control information determination device determines the flight mode of the spraying UAV based on the one or more of the height information of the branches and leaves, the horizontal spreading range of the branches and leaves, and the density coefficient of the branches and leaves.

In some embodiments, the flight mode includes at least one of rotation of the spraying UAV, spiral circulation of the spraying UAV, repetitive ascending and descending of the spraying UAV, or horizontal circulation of the spraying UAV.

For example, if the horizontal spreading range of the branches and leaves of a fruit tree is small and the density coefficient of the branches and leaves indicates sparsity, the flight mode is determined to be the rotation of the spraying UAV as shown in FIG. 5. For example, the spraying UAV sprays over the fruit tree while self-rotating. The wind resulted from the rotation of the spraying UAV blows the sparsely distributed branches and leaves to allow both the front and the back of the leaves of the fruit tree to receive sprayed solution.

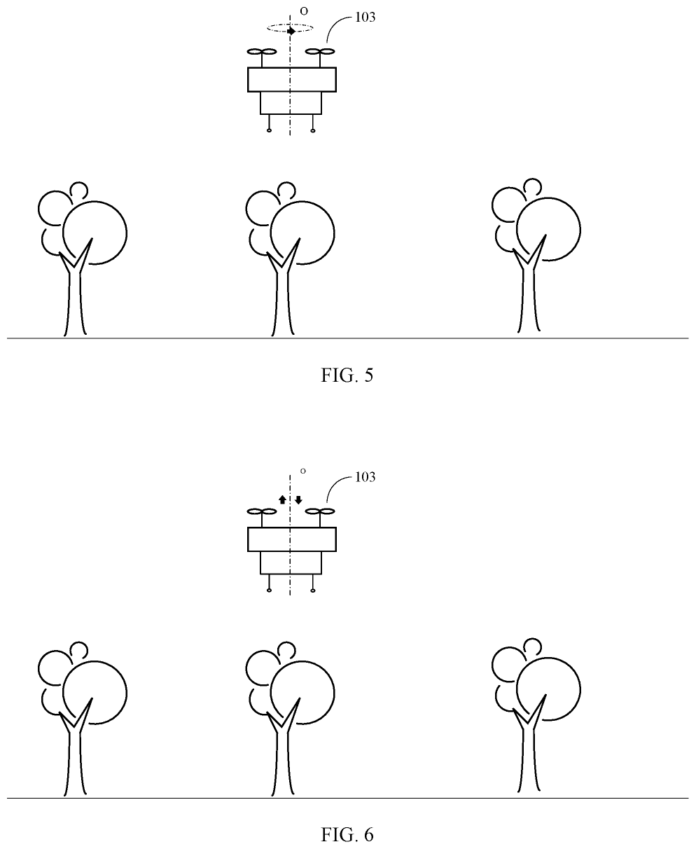

If the horizontal spreading range of the branches and leaves of a fruit tree is small and the density coefficient of the branches and leaves indicates high density, the flight mode is determined to be the rotation of the spraying UAV as shown in FIG. 5 and the repetitive ascending and descending of the spraying UAV as shown in FIG. 6. For example, the spraying UAV sprays over the fruit tree while self-rotating and repetitively ascending and descending. The wind resulted from the rotation and repetitive ascending and descending of the spraying UAV blows the densely distributed branches and leaves to allow both the front and the back of the leaves of the fruit tree to receive the sprayed solution.

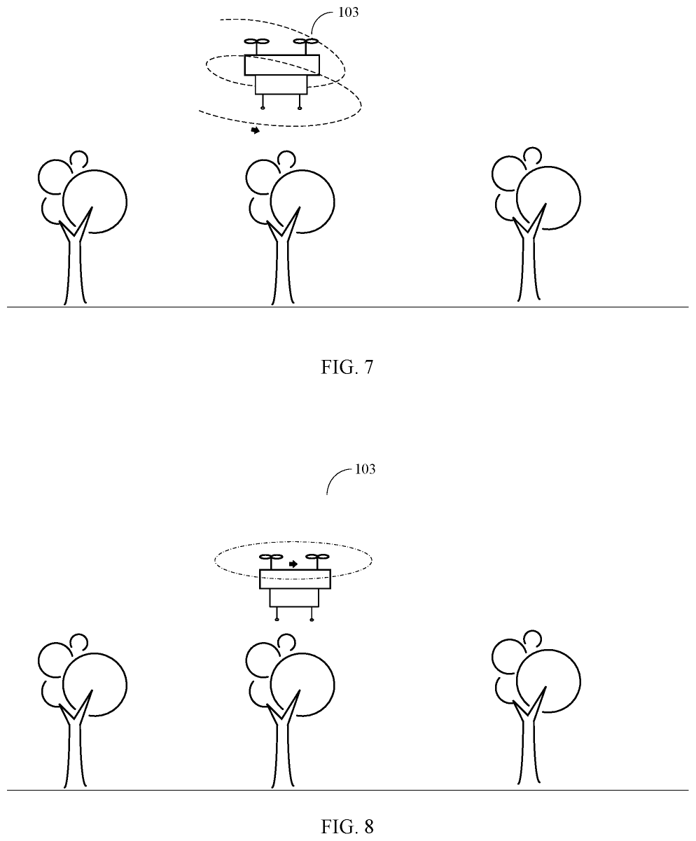

If the horizontal spreading range of the branches and leaves of a fruit tree is large and the density coefficient of the branches and leaves indicates sparsity, the flight mode is determined to be the spiral circulation of the spraying UAV as shown in FIG. 7. For example, the spraying UAV sprays over the fruit tree while spirally circling. The wind resulted from the spiral circulation of the spraying UAV blows the densely distributed branches and leaves to allow both the front and the back of the leaves of the fruit tree to receive the sprayed solution.

If the horizontal spreading range of the branches and leaves of a fruit tree is large and the density coefficient of the branches and leaves indicates high density, the flight mode is determined to be the spiral circulation of the spraying UAV as shown in FIG. 7 and the repetitive ascending and descending of the spraying UAV as shown in FIG. 6. For example, the spraying UAV sprays over the fruit tree while spirally circling and repetitively ascending and descending to allow the entire fruit tree to receive the sprayed solution.

If the height information of the branches and leaves of a fruit tree indicates that the leaves are relatively flat, the flight mode is determined to be the horizontal circulation of the spraying UAV as shown in FIG. 8 to allow the entire fruit tree to receive the sprayed solution.

In some embodiments, the spraying control information determination device determines at least one of the spraying intensity or the spraying density of the spraying UAV based on the crop type and/or the pest damage coefficient of the target crop. The spraying intensity and the spraying density of the spraying UAV may determine a desired amount of the sprayed solution to ensure that growth of the target crop is not affected by spraying an excessive amount of the sprayed solution and removal of pests is not compromised by spraying an insufficient amount of the sprayed solution.

In some embodiments, after the spraying control information determination device determines the spraying control information, the spraying control information may be uploaded to a cloud sever. As such, when the target crop area needs to be sprayed again, the spraying UAV or the ground control terminal of the spraying UAV may download the spraying control information from the cloud server. Thus, the spraying control information generated from the 3D spatial information obtained by one-time surveying of the target crop area may be reused for multiple spraying of the target crop area without limiting the spraying of the target crop area by the same spraying UAV.

In some embodiments, to determine the spraying control information, the spraying control information determination device transmits the 3D spatial information to a server for the server to determine the status information of the target crop in the target crop area based on the 3D spatial information, receives the status information of the target crop in the target crop area transmitted by the server, and determines the spraying control information for controlling the spraying UAV to perform spraying on the plurality of target crops based on the status information of the target crop.

In some embodiments, the spraying control information determination device transmits the obtained 3D spatial information to the server. The server receives the 3D spatial information transmitted by the spraying control information determination device, determines the status information of the target crop in the target crop area based on the 3D spatial information, and transmits the status information of the target crop to the spraying control information determination device. The spraying control information determination device receives the status information of the target crop transmitted by the server.

For how the server determines the status information of the target crop in the target crop area based on the 3D spatial information, reference can be made to the related description of how the spraying control information determination device determines the status information of the target crop in the target crop area based on the 3D spatial information, and is omitted herein.

In some other embodiments, to determine the spraying control information, the spraying control information determination device transmits the 3D spatial information to the server for the server to determine the status information of the target crop in the target crop area based on the 3D spatial information and determine the spraying control information for controlling the spraying UAV to perform spraying on the plurality of target crops based on the status information of the target crop, and receives the spraying control information transmitted by the server.

For how the server determines the status information of the target crop in the target crop area based on the 3D spatial information, reference can be made to the related description of how the spraying control information determination device determines the status information of the target crop in the target crop area based on the 3D spatial information, which is omitted herein.

For how the server determines the spraying control information for controlling the spraying UAV to spray the plurality of target crops based on the status information of the target crop, reference can be made to the related description that the spraying control information determination device determines the spraying control information for controlling the spraying UAV to spray the plurality of target crops based on the status information of the target crop, which is omitted herein.

In some other embodiments, to determine the spraying control information, the spraying control information determination device determines the status information of the target crop in the target crop area based on the 3D spatial information, transmits the status information of the target crop in the target crop area to the server for the server to determine the spraying control information for controlling the spraying UAV to perform spraying on the plurality of target crops based on the status information of the target crop, and receives the spraying control information transmitted by the server.

For how the server determines the spraying control information for controlling the spraying UAV to spray the plurality of target crops based on the status information of the target crop, reference can be made to the related description of how the spraying control information determination device determines the spraying control information for controlling the spraying UAV to spray the plurality of target crops based on the status information of the target crop, which is omitted herein.

Referring again to FIG. 4, at S405, the spraying UAV obtains the spraying control information for controlling the spraying UAV to perform spraying on the plurality of target crops planted in the target crop area.

In some embodiments, the spraying UAV obtains the spraying control information for controlling the spraying UAV to perform spraying on the plurality of target crops. The spraying control information is determined based on the 3D spatial information of the target crop area. The detail description can be referred to the description of S403-S404, and is omitted herein. In some embodiments, the 3D spatial information is determined based on the images outputted by the photographing device when the surveying UAV is flying in the target crop area. For the detail description, reference can be made to the description of S401-S402, which is omitted herein.

In some embodiments, the spraying UAV and the spraying control information determination device may communicate with each through a wired communication connection or a wireless communication connection. After the spraying control information determination device executes S404, the spraying control information determination device transmits the spraying control information through the wired communication connection or the wireless communication connection. Correspondingly, a possible implementation of S405 includes that the spraying UAV receives the spraying control information transmitted by the spraying control information determination device through the wired communication connection or the wireless communication connection.

In some embodiments, after the spraying control information determination device executes S404, the spraying control information determination device stores the spraying control information in the storage device. Correspondingly, a possible implementation of S405 includes that the spraying UAV obtains the spraying control information from the storage device. The storage device may be, for example, the SD card. The spraying control information determination device may store the obtained the spraying control information in the SD card. The user removes the SD card from the spraying control information determination device and plug the SD card into the spraying UAV. The spraying UAV obtains the spraying control information from the plugged-in SD card.

At S406, the spraying UAV performs spraying on each target crop according to the corresponding spraying mode for each target crop.

In some embodiments, after the spraying UAV obtains the spraying control information, the spraying UAV performs spraying on each target crop planted in the target crop area according to the corresponding spraying mode for each target crop.

In some embodiments, the spraying control information also includes the flight route that the spraying UAV flies between the plurality of target crops. Correspondingly, the spraying UAV flies between the plurality of target crops based on the flight route.

In some embodiments, when the spraying UAV flies between the plurality of target crops, the spraying UAV may also turn off its spraying function.

A flying speed at which the spraying UAV flies between the plurality of target crops may be faster than the flying speed at which the spraying UAV sprays each target crop. Thus, the spraying UAV consistent with the present disclosure may adjust the flying speed to save a total spraying operation time for the target crop area, thereby improving operation efficiency.

In some embodiments, when the spraying UAV is spraying, the spraying UAV monitors information such as remaining battery power and remaining amount of the sprayed solution in real time. When insufficient battery power, insufficient amount of the sprayed solution, or other related conditions cause the spraying UAV to terminate a spraying task, the spraying UAV automatically records a termination point position of the spraying task and the corresponding spraying mode. When the spraying UAV resumes the spraying operation, the spraying UAV may alert the user to resume a last interrupted spraying task. After the user confirms, the spraying UAV may fly to the termination point position of the last interrupted spraying task to continue the last interrupted spraying task. In this way, the spraying UAV ensures that no flight route is omitted or repeated and no fruit tree is skipped or repeated in the spraying operation, thereby ensuring accuracy and efficiency of the entire spraying task.

In some embodiments, an executer of S405 and S406 may be a control device of the spraying UAV.

In the embodiments of the present disclosure, when the surveying UAV is flying in the target crop area, the surveying UAV obtains the images outputted by the photographing device. The plurality of target crops are planted in the target crop area. The 3D spatial information of the target crop area is obtained based on the images. The spraying control information determination device obtains the 3D spatial information and determines the spraying control information for controlling the spraying UAV to spray the plurality of target crops based on the 3D spatial information. The spraying control information includes the spraying mode for controlling the spraying UAV to spray each corresponding target crop of the plurality of target crops. The spraying mode includes the flight mode. The spraying UAV obtains the spraying control information, and sprays each corresponding target crop according to the spraying mode for each target crop. Because the spraying control information is determined based on the 3D spatial information of the target crop area, the spraying operation time may be reduced, thereby saving operation time cost and improving spraying efficiency. At the same time, it can be ensured that the spraying effect is desired for various target crops. Thus, the degrees of intelligence and convenience of the spraying operation of the spraying UAV are improved.

The present disclosure also provides a computer storage medium. The computer storage medium stores program instructions. When being executed, the program instructions perform some or all of steps of the control method shown in FIG. 4 and the corresponding embodiments.

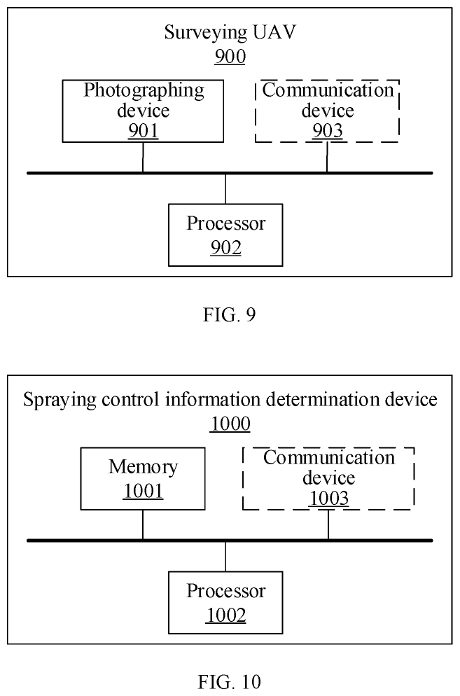

FIG. 9 is a structural diagram of a surveying UAV 900 according to an example embodiment of the present disclosure. As shown in FIG. 9, the surveying UAV 900 includes a photographing device 901 configured to collect images and a processor 902 configured to obtain the images outputted by the photographing device 901 when the surveying UAV is flying in the target crop area. The photographing device 901 and the processor 902 are connected via a bus. In some embodiments, the surveying UAV 900 further includes a communication device 903 connected with the processor 902 via the bus.

The target crop area is planted with the plurality of target crops. The processor 902 obtains the 3D spatial information of the target crop area based on the images. The 3D spatial information is used to determine the spraying control information for controlling the spraying UAV to spray the plurality of target crops. The spraying control information includes the spraying mode for controlling the spraying UAV to spray each of the plurality of target crops. The spraying mode includes the flight mode.

In some embodiments, the communication device 903 is configured to transmits the 3D spatial information to the spraying control information determination device through the wired communication connection or the wireless communication connection, such that the spraying control information determination device determines the spraying control information based on the 3D spatial information.

In some embodiments, the processor 902 stores the 3D spatial information in the storage device, such that the spraying control information determination device obtains the 3D spatial information from the storage device and determines the spraying information based on the 3D spatial information.

In some embodiments, the processor 902 obtains location information of the surveying UAV and an attitude of the photographing device when the surveying UAV is flying in the target crop area.

When the processor 902 obtains the 3D spatial information of the target crop area based on the images, the processor 902 obtains the 3D spatial information of the target crop area based on the images, the location information and the attitude.

In some embodiments, the 3D spatial information includes 3D point cloud information or 3D map information.

In some embodiments, the spraying control information further includes the flight route along which the spraying UAV flies among the plurality of target crops in the target crop area.

In some embodiments, the spraying mode further includes one or more of spraying intensity and spraying density.

In some embodiments, the flight mode includes at least one of the rotation of the spraying UAV, the spiral circulation of the spraying UAV, the repetitive ascending and descending of the spraying UAV, or the horizontal circulation of the spraying UAV.

In some embodiments, the target crops are trees.

In some embodiments, the trees are fruit trees.

In some embodiments, the survey UAV 900 further includes a storage device (not shown). The storage device stores program codes. When the program codes are executed, the surveying UAV 900 implements the method embodiments of the present disclosure.

The surveying UAV consistent with the present disclosure can be used to implement the methods in the above-described embodiments of the present disclosure to achieve similar technical effects based on similar operation principles, which will not be repeated herein.

FIG. 10 is a structural diagram of a spraying control information determination device 1000 according to an example embodiment of the present disclosure. As shown in FIG. 10, the spraying control information determination device 1000 includes a memory 1001 storing program codes and a processor 1002 configured to execute the program codes stored in the memory 1001. The memory 1001 and the processor 1002 are connected via a bus. In some embodiments, the spraying control information determination device 1000 further includes a communication device 1003. The communication device 1003 and the processor 1002 are connected via the bus.

When the program codes are executed by the processor 1002, the programs codes perform obtaining the 3D spatial information of the target crop area planted with the plurality of target crops, determining the spraying control information based on the 3D spatial information, and controlling the spraying UAV to perform spraying on the plurality of target crops based on the 3D spraying control information. The spraying control information includes the spraying mode for controlling the spraying UAV to perform spraying on one target crop of the plurality of target crops. The spraying mode includes the flight mode.

In some embodiments, when determining the spraying control information based on the 3D spatial information, the processor 1002 is configured to determine the crop status information of the plurality of target crops based on the 3D spatial information and to determine the spraying control information based on the crop status information.

In some embodiments, the communication device 1003 is configured to transmit the 3D spatial information to the server and to receive the spraying control information transmitted by the server. When the processor 1002 determines the spraying control information based on the 3D spatial information, the processor 1002 is configured to control the communication device 1003 to transmit the 3D spatial information to the server, such that the server determines the spraying control information based on the 3D spatial information. The processor 1002 is configured to control the communication device 1003 to receive the spraying control information transmitted by the server.

In some embodiments, when the processor 1002 determines the crop status information of the plurality of target crops based on the 3D spatial information, the processor 1002 is configured to input the 3D spatial information into a pre-configured neural network model to obtain the crop status information of the plurality of target crops outputted from the pre-configured neural network model.

In some embodiments, the crop status information includes the location information of the plurality of target crops and the quantity of the plurality of target crops. The spraying control information further includes the flight route along which the spraying UAV flies among the plurality of target crops. When the processor 1002 determines the spraying control information for controlling the spraying UAV to perform spraying on the plurality of target crops based on the crop status information, the processor 1002 is configured to determine the flight route along which the spraying UAV flies among the plurality of target crops based on the location information of the plurality of target crops and the quantity of the plurality of target crops.

In some embodiments, the crop status information includes the growth information of the plurality of target crops. When the processor 1002 determines the spraying control information for controlling the spraying UAV to perform spraying on the plurality of target crops based on the crop status information, the processor 1002 is configured to determine the spraying mode for controlling the spraying UAV to perform spraying on the plurality of target crop based on the growth information for each of the plurality of target crops.

In some embodiments, the growth information includes at least one of a crop type of the plurality of target crops, a density coefficient of branches and leaves, a pest damage coefficient, a horizontal spreading range of branches and leaves, or height information of branches and leaves.

In some embodiments, the spraying mode includes one or more of the flight mode, the spraying intensity, and the spraying density.

In some embodiments, when the processor 1002 determines the spraying mode for controlling the spraying UAV to perform spraying on the plurality of target crops based on the growth information for each of the plurality of target crops, the processor 1002 is configured to determine the flight mode of the spraying UAV based on one or more of the height information of branches and leaves, the horizontal spreading range of branches and leaves, and the density coefficient of branches and leaves.

In some embodiments, the flight mode includes at least one of the rotation of the spraying UAV, the spiral circulation of the spraying UAV, the repetitive ascending and descending of the spraying UAV, or the horizontal circulation of the spraying UAV.

In some embodiments, the communication device 1003 is configured to transmit the spraying control information to the spraying UAV. The processor 1002 is configured to control the communication device 1003 to transmit the spraying control information to the spraying UAV, or to store the spraying control information in the storage device, such that the spraying UAV obtains the spraying control information from the storage device.

In some embodiments, the 3D spatial information includes the 3D point cloud information or the 3D map information.

In some embodiments, the target crops are trees.

In some embodiments, the trees are fruit trees.

In some embodiments, the 3D spatial information is determined based on the images outputted by the photographing device disposed at the surveying UAV when the surveying UAV is flying in the target crop area.

In some embodiments, the communication device 1003 is configured to receive the 3D spatial information transmitted by the surveying UAV through the wired communication connection or the wireless communication connection. When the processor 1002 obtains the 3D spatial information of the target crop area, the processor 1002 is configured to control the communication device 1003 to receive the 3D spatial information transmitted by the surveying UAV through the wired communication connection or the wireless communication connection, or to obtain the 3D spatial information from the storage device, which is stored in the storage device by the surveying UAV.

The spraying control information determination device consistent with the embodiments of the present disclosure can be used to implement the methods in the above-described embodiments of the present disclosure to achieve similar technical effects based on similar operation principles, which will not be repeated herein.

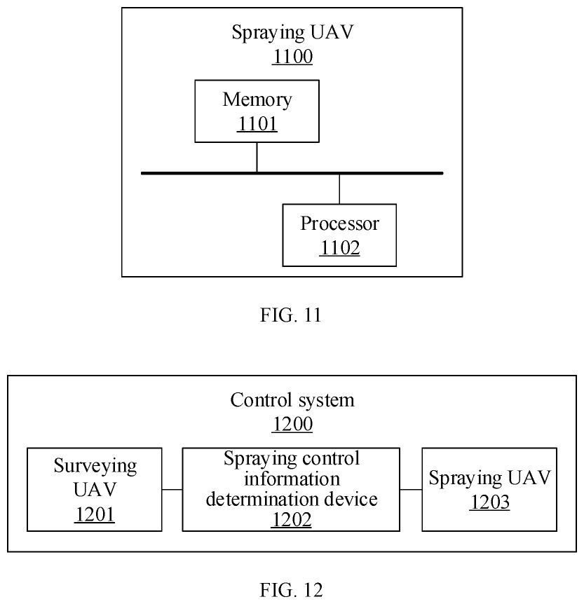

FIG. 11 is a structural diagram of a spraying UAV 1100 according to an example embodiment of the present disclosure. As shown in FIG. 11, the spraying UAV 1100 includes a memory 1101 storing program codes and a processor 1102 to execute the program codes stored in the memory 1101. The memory 1101 and the processor 1102 are connected via a bus.

When the program codes are executed by the processor 1102, the programs codes perform obtaining the spraying control information for controlling the spraying UAV 1100 to perform spraying on the plurality of target crops planted in the target crop area and controlling the spraying UAV 1100 to spray each of the plurality of target crops based on the spraying mode. The spraying control information is determined based on the 3D spatial information of the target crop area. The spraying control information includes the spraying mode for controlling the spraying UAV to spray each of the plurality of target crops. The spraying mode includes the flight mode.

In some embodiments, the spraying control information further includes the flight route along which the spraying UAV 1100 flies among the plurality of target crops. The processor 1102 is further configured to control the spraying UAV 1100 to fly among the plurality of target crops based on the flight route.

In some embodiments, the spraying mode includes one or more of the flight mode, the spraying intensity, and the spraying density.

In some embodiments, the flight mode includes at least one of the rotation of the spraying UAV, the spiral circulation of the spraying UAV, the repetitive ascending and descending of the spraying UAV, or the horizontal circulation of the spraying UAV.

In some embodiments, the 3D spatial information includes the 3D point cloud information or the 3D map information.

In some embodiments, the target crops are trees.

In some embodiments, the trees are fruit trees.

In some embodiments, the spraying control information further includes the flight route along which the spraying UAV 1100 flies among the plurality of target crops. The processor 1102 is further configured to control the spraying UAV 1100 to fly among the plurality of target crops based on the flight route.

The spraying UAV consistent with the embodiments of the present disclosure can be used to implement the methods in the above-described embodiments of the present disclosure to achieve similar technical effects based on similar operation principles, which will not be repeated herein.

FIG. 12 is a structural diagram of a control system 1200 according to an example embodiment of the present disclosure. As shown in FIG. 12, the control system 1200 includes a surveying UAV 1201, a spraying control information determination device 1202, and a spraying UAV 1203.

The surveying UAV 1201 has the structure as shown in FIG. 9. Correspondingly, the surveying UAV 1201 can be used to implement the methods in the above-described embodiments of the present disclosure to achieve similar technical effects based on similar operation principles, which will not be repeated herein.

The spraying control information determination device 1202 has the structure as shown in FIG. 10. Correspondingly, the spraying control information determination device 1202 can be used to implement the methods in the above-described embodiments of the present disclosure to achieve similar technical effects based on similar operation principles, which will not be repeated herein.

The spraying UAV 1203 has the structure as shown in FIG. 11. Correspondingly, the spraying UAV 1203 can be used to implement the methods in the above-described embodiments of the present disclosure to achieve similar technical effects based on similar operation principles, which will not be repeated herein.

Those skilled in the art should understand that all or some of the processes in above-described the embodiments of the present disclosure may be implemented by instructing relevant hardware through a computer program. The computer program may be stored in a computer-readable storage medium. When being executed, the computer program includes the processes of the above-described method embodiments. The storage medium may be a magnetic disk, an optical disk, a read-only memory (ROM), or a random-access memory (RAM), etc.

In the specification, specific examples are used to explain the principles and implementations of the present disclosure. The description of the embodiments is intended to assist comprehension of the methods and core inventive ideas of the present disclosure. At the same time, those of ordinary skill in the art may change or modify the specific implementation and the scope of the application according to the embodiments of the present disclosure. Thus, the content of the specification should not be construed as limiting the present disclosure.

What is claimed is:

1. A control method comprising:
obtaining three-dimensional (3D) spatial information of a target crop area planted with a plurality of target crops;
determining spraying control information based on the 3D spatial information; and
controlling a spraying unmanned aerial vehicle (UAV) to perform spraying on the plurality of target crops based on the spraying control information;
wherein the spraying control information includes a spraying mode for controlling the spraying UAV to perform spraying on one target crop of the plurality of target crops, and the spraying mode includes a flight mode.

2. The method according to claim 1, wherein determining the spraying control information based on the 3D spatial information includes:
transmitting the 3D spatial information to a server for the server to determine the spraying control information based on the 3D spatial information; and
receiving the spraying control information transmitted by the server.

3. The method according to claim 1, wherein determining the spraying control information based on the 3D spatial information includes:
determining crop status information of the plurality of target crops based on the 3D spatial information; and
determining the spraying control information based on the crop status information.

4. The method according to claim 3, wherein determining the crop status information based on the 3D spatial information includes:
inputting the 3D spatial information into a pre-configured neural network model; and
obtaining the crop status information outputted by the pre-configured neural network model.

5. The method according to claim 3, wherein:
the crop status information includes location information of the plurality of target crops and a quantity of the plurality of target crops; and
determining the spraying control information based on the crop status information includes determining a flight route along which the spraying UAV flies among the plurality of target crops based on the location information of the plurality of target crops and the quantity of the plurality of target crops.

6. The method according to claim 3, wherein:
the crop status information includes growth information of the plurality of target crops; and
determining the spraying control information based on the crop status information includes determining the spraying mode for the one target crop based on the growth information for the one target crop.

7. The method according to claim 6, wherein:
the growth information includes at least one of a crop type, a density coefficient of branches and leaves, a pest damage coefficient, a horizontal spreading range of branches and leaves, or height information of branches and leaves.

8. The method according to claim 7, wherein:
the spraying mode further includes one or more of a spraying intensity and a spraying density.

9. The method according to claim 6, wherein:
determining the spraying mode for the one target crop based on the growth information for the one target crop incudes determining the flight mode of the spraying UAV based on one or more of the height information of branches and leaves, the horizontal spreading range of branches and leaves, and the density coefficient of branches and leaves.

10. The method according to claim 1, wherein:
the flight mode includes at least one of rotation of the spraying UAV, spiral circulation of the spraying UAV, repetitive ascending and descending of the spraying UAV, or horizontal circulation of the spraying UAV.

11. The method according to claim 1, further comprising:
transmitting the spraying control information to the spraying UAV; or
storing the spraying control information in a storage device.

12. The method according to claim 1, wherein:
the 3D spatial information includes 3D point cloud information or 3D map information.

13. The method according to claim 1, wherein:
the target crops include trees.

14. The method according to claim 13, wherein:
the trees include fruit trees.

15. The method according to claim 1, wherein:
the 3D spatial information is determined based on images outputted by a photographing device disposed at a surveying UAV when the surveying UAV is flying in the target crop area.

16. The method according to claim 15, wherein obtaining the 3D spatial information of the target crop area includes:
receiving the 3D spatial information transmitted by the surveying UAV through a wired communication connection or a wireless communication connection; or
obtaining the 3D spatial information from a storage device, the 3D spatial information being stored in the storage device by the surveying UAV.

17. A device comprising:
a memory storing program codes; and
a processor configured to execute the program codes to:
obtain three-dimensional (3D) spatial information of a target crop area planted with a plurality of target crops;
determine spraying control information based on the 3D spatial information; and
control a spraying unmanned aerial vehicle (UAV) to perform spraying on the plurality of target crops based on the spraying control information;
wherein the spraying control information includes a spraying mode for controlling the spraying UAV to perform spraying on one target crop of the plurality of target crops, and the spraying mode includes a flight mode.

18. The device according to claim 17, wherein:
crop status information includes location information of the plurality of target crops and a quantity of the plurality of target crops; and
when determining the spraying control information based on the crop status information, the processor is configured to determine a flight route along which the spraying UAV flies among the plurality of target crops based on the location information of the plurality of target crops and the quantity of the plurality of target crops.

19. The device according to claim 17, wherein:
crop status information includes growth information of the plurality of target crops; and
when determining the spraying control information based on the crop status information, the processor is configured to determine the spraying mode for the one target crop based on the growth information for the one target crop.

20. The device according to claim 17, wherein:
the 3D spatial information includes 3D point cloud information or 3D map information.

21. The device according to claim 17, wherein:
the 3D spatial information is determined based on images outputted by a photographing device disposed at a surveying UAV when the surveying UAV is flying in the target crop area.
